(19) United States
(12) Patent Application Publication
(10) Pub. No.: US 2009/0103884 A1
(43) Pub. Date: Apr. 23, 2009

(54) Method For Producing Rewritable Photonic Devices

(76) Inventors: Diederik Sybolt Wiersma, Vaglia (IT); Silvia Vignolini, Vaiano (IT); Volker Turck, Berlin (DE); Francesca Intonti, Florence (IT)

Correspondence Address: COOK ALEX LTD, SUITE 2850, 200 WEST ADAMS STREET, CHICAGO, IL, 60606, US

(21) Appl. No.: 12/293,185

(22) PCT Filed: Mar. 21, 2007
(86) PCT No.: PCT/IB2007/050989

§ 371 Date: Sep. 16, 2008

(30) Foreign Application Priority Data
Mar. 22, 2006 (IT) TO2006A000216

(51) Int. Cl. G02B 6/10

(52) U.S. Cl. 385/147

(57) ABSTRACT

Method for the creation of a rewritable photonic device inserted in a photonic crystal (2) having a plurality of cavities (6); this method comprises the operation of injecting selectively a micro-quantity of a liquid (12) into predetermined cavities (6) so as to allow the introduction of permitted states within the photonic band gap of the crystal or modification of the prohibited states.

The present invention relates to a method for producing a spatially rewritable photonic device.

In modern telecommunications and electronics technology there is a trend towards the creation of optical devices and circuits. In order to produce these components photonic crystals, also called photonic band gap materials, are used.

A photonic crystal is a dielectric material with periodic variations in the dielectric constant. This phenomenon has an influence on the propagation of light which is similar to that which the atomic crystal potential has on the electronic structure. This periodic variation results in fact in the formation of a prohibited optical band, in a very similar manner to that which occurs within semiconductors as regards the energy levels which are prohibited for the electrons.

Electromagnetic waves with a frequency within a certain range, called the photonic band gap, are unable to propagate inside the photonic crystal and also the spontaneous emission of light is prevented within this frequency range.

The central frequency and the width of this energy gap depend on the variation in the refractive index, which in these materials may be modified externally.

The introduction of defects within the photonic crystal results in the formation of permitted energy states within the photonic band gap or results in modification of the prohibited states.

A two-dimensional photonic crystal is constructed by creating within a homogeneous planar structure a periodic effect in two directions; this may be obtained, for example, by forming a periodic succession of cylindrical pores which extend over the entire thickness of the planar structure.

The introduction of defects into this photonic crystal allows the propagation of modes within the range of frequencies which belong to the photonic band gap or results in the formation of localized states.

The creation of these defects is, however, a technically complex operation. The current technology for the creation of these defects consists, for example, in the insertion of pores with dimensions different from those forming the crystal or in the elimination of some pores from the porous matrix.

One object of the present invention is to propose an innovative method for the introduction of defects in a photonic crystal so as to be able to construct easily photonic devices and circuits which are rewritable or able to be written, erased and rewritten.

These and other objects are achieved according to the invention by a method and a device, the main characteristic features of which are defined in the appended claims.

According to the method of the invention, the defects are created by means of selective injection of a liquid into predetermined pores of the photonic crystal, in a pattern suitable for allowing the propagation of specific wavelengths which are otherwise inhibited.

In principle the liquid used may be any liquid which has a viscosity such as to allow the supply thereof by means of a micropipette.

The volatility and the viscosity of the liquid may be chosen depending on the desired stability characteristics of the photonic device.

Further characteristics and advantages of the invention will become clear from the detailed description which follows, provided purely by way of a non-limiting example with reference to the appended drawings in which:

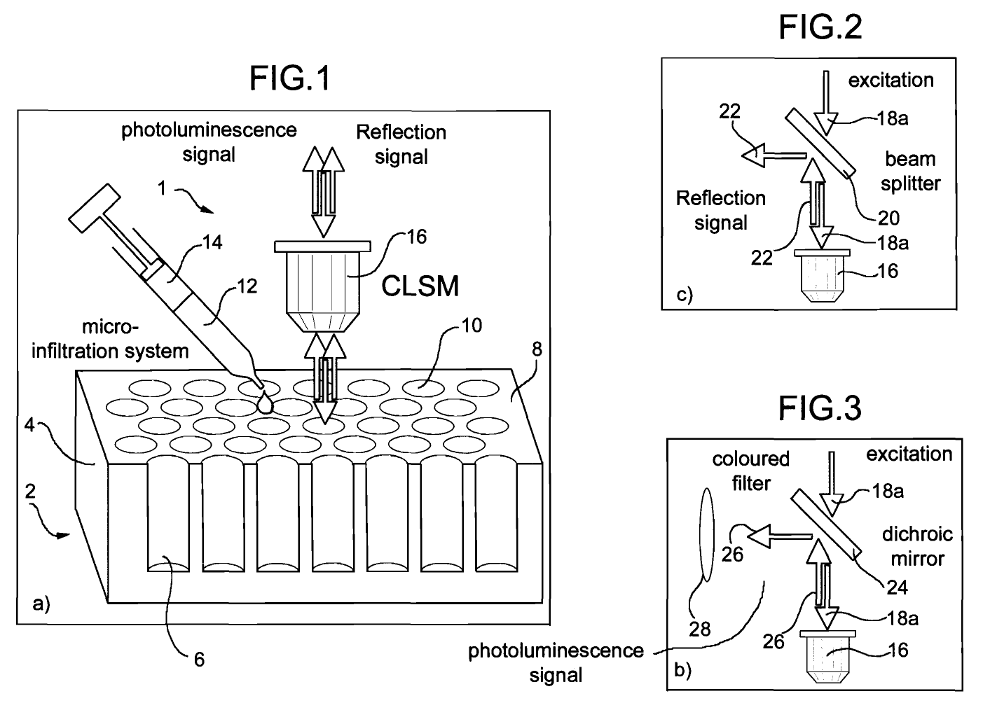

FIG. 1 is a diagram of the test apparatus used to implement the method according to the invention;

FIG. 2 is a diagram illustrating operation in reflection mode of a microscope, used to monitor the infiltration process;

FIG. 3 is a diagram illustrating operation in luminescence mode of the microscope according to FIG. 2;

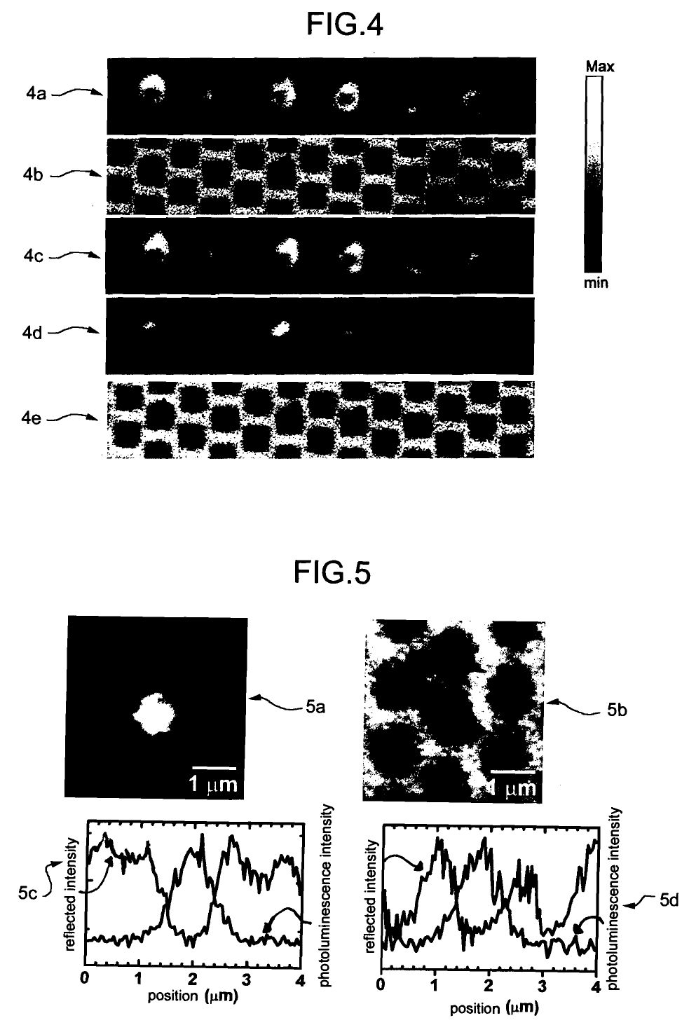

FIG. 4 is an image of a sample infiltrated using the method according to the invention;

FIG. 5 is an image showing a detail of a sample with the respective photoluminescence graphs;

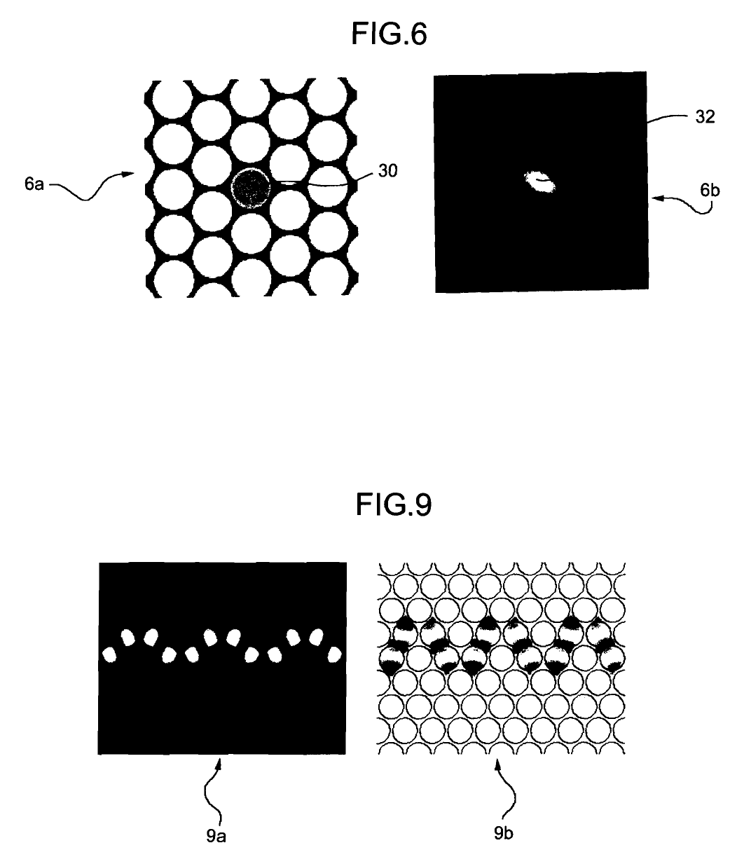

FIG. 6 is an image showing the variation of the dielectric constant and the spatial distribution of the mode TE of the detail according to FIG. 5;

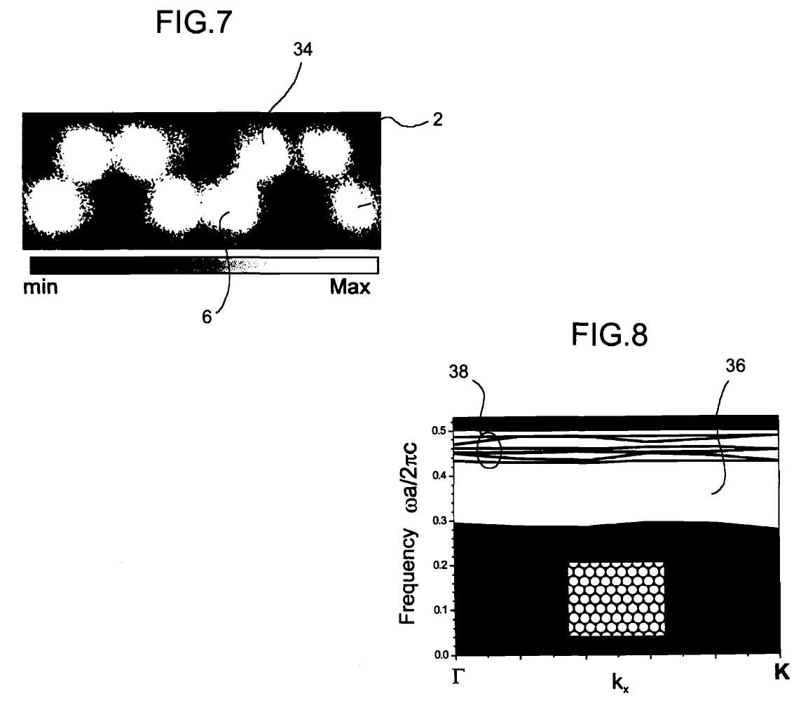

FIG. 7 is an image showing a waveguide created with the method according to the invention;

FIG. 8 is the band diagram for the modes TE of the structure shown in FIG. 7;

FIG. 9 shows the intensity of the electric field and the magnetic field associated with a mode TE of the guide according to FIG. 8; and

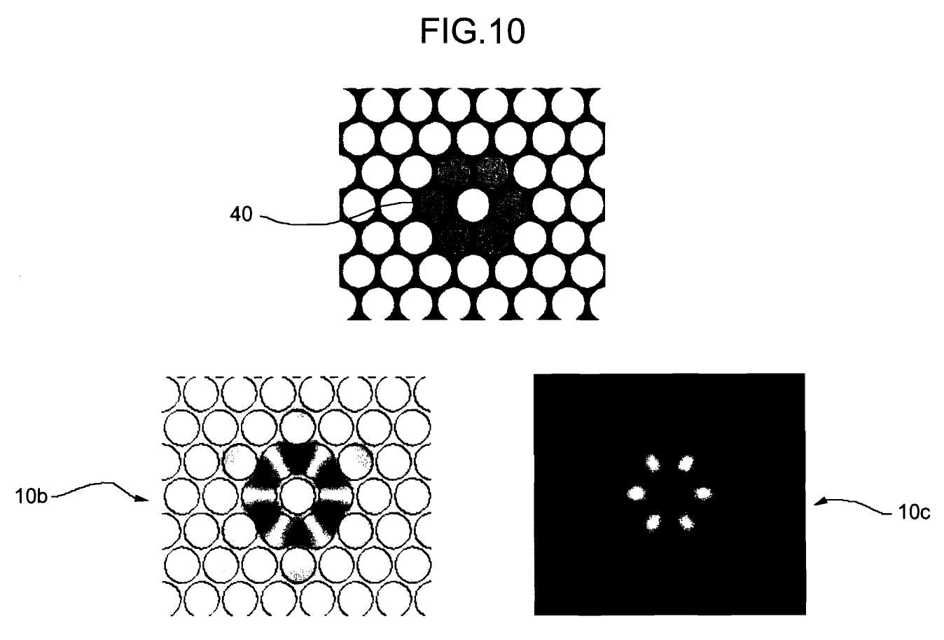

FIG. 10 is an image showing the electric and magnetic fields associated with a mode TE of an annular cavity created with the method according to the invention.

In FIG. 1, 1 denotes the test apparatus used for implementing the method according to the invention.

This apparatus 1 comprises a two-dimensional photonic crystal 2 consisting of a support 4 and a plurality of cylindrical cavities 6. These cavities 6 open out only on one side 8 of the support 4 by means of circular holes 10.

These cavities 6 are infiltrated with a liquid 12 supplied by means of a micropipette 14. Carrying out of this infiltration method requires very precise monitoring of the entire test apparatus since the typical quantities of liquid which must be introduced into the cavities 6 of the photonic crystal 2 are of the order of tenths of femtolitres, i.e. about four orders of magnitude smaller than the quantity of liquid which emerges from the most sophisticated ink jet printer heads. The infiltration process is monitored by a confocal laser scan microscope (CLSM) indicated in FIG. 1 by 16. This microscope is typically mounted on a standard commercial microscope and is equipped with a microinfiltration system developed for molecular applications, in order to transfer controlled quantities of liquid inside cells.

The microinfiltration system consists of a series of micropipettes 14 which have an outer diameter of between 0.1 μm and 1 μm and which may be moved, over the surface of the sample, with a precision less than or equal to 0.1 μm. The hydraulic transmission of the movement of the pipettes reduces drastically the vibrations.

When the pipette is situated in the correct position on the sample, a controlled pressure is applied to it. The force exerted by this pressure produces infiltration of the liquid. In general it is preferable to use a liquid, the vapour tension of which is such that the liquid infiltrated into the pores is not subject to total evaporation at room temperature for a period of at least one day.

Since the capillary forces slow down enormously the evaporation inside the pores, liquids which are relatively volatile such as water or hydrocarbons are also used. These capillary forces are able to retain the liquid inside the cavities even if the latter should not be through-holes or should not be closed at one end as in the example described here; this is possible owing to the fact that the capillary forces which arise in these cases, where the diameters of the holes are very small, are greater than the corresponding force of gravity which would otherwise tend to cause the liquid to flow out.

Other liquids which may be used with success in this method are suspensions of micro or nano-particles, such as quantum dots, in a liquid, or oils, which may be used to obtain photonic devices which are stable for a prolonged period of several years or so.

An alternative which is of particular interest is that of liquid crystals. These are of particular interest since they have a refractive index which depends on the temperature and on a possible external electric field which is applied to them. In this case it is possible to produce tunable devices, namely devices which vary their performance depending on the temperature variation or the electric field applied. For example, it is possible to produce a diverter able to send light in different directions upon variation of the electric field applied locally at different points of the photonic crystal.

The tunability of a device may, moreover, also be obtained by mixing two or more liquids which have a different refractive index.

The removal of the liquid from the pores in order to allow rewriting of the device may be performed, for example, by arranging the infiltrated photonic crystal inside an ultrasound bath.

In order to obtain permanent (non rewritable) photonic devices it is also envisaged the use of liquids which are capable of hardening or crosslinking, such as resist or liquid prepolymers, for example.

In a preferred embodiment a tracer, for example a fluorescent dye, able to emit a radiation in the visible range when excited, is added to the liquid. The presence of this tracer allows the infiltration steps to be monitored, allowing location of the liquid inside the pores.

In an example of embodiment of this method it is possible to infiltrate into the cavities of a two-dimensional photonic crystal a solution of water and Rhodamina 6G, an organic tincture which, when suitably excited, emits light in the visible range. The photonic crystal may be, for example, a macroporous silicon sample produced by means of electrochemical etching of a silicon substrate of the type p; the pores may be organized in a triangular symmetry, characterized by two different lattice constants equal to 1.5 μm and 4.2 μm.

The chemical and physical properties of the infiltrated solution are very interesting: firstly the refractive index of the aqueous solution is 1.33 and, since the solution acts as a local defect, states permitted within the photonic band gap are thus created. The viscosity of the liquid is 1 mPa/s and therefore it is such as to facilitate the deposition thereof inside the cavities of the crystal. Finally, owing to the luminescence of the solution, it is possible to verify the correct execution of the infiltration step by observing the surface of the sample with the CLSM microscope in the luminescence configuration. If the solution should not be luminescent this verification may be performed using the CLSM in reflection mode. These two operating modes of the microscope will be explained below.

The emission properties of the organic tincture depend, in general, on the solvent in which they are dissolved. The solution of Rhodamina 6G and water is characterized by a slightly asymmetrical emission spectrum centred around 550 nm, with a small tail on the side of the greater wavelengths. When the water evaporates the emission spectrum changes, the position of the peak moves to 570 nm and the asymmetry becomes more pronounced towards greater wavelengths. This shift towards red of the emission provides a valuable mechanism for monitoring the evolution over time, and therefore the evaporation, of defects introduced intentionally.

FIG. 2 shows operation of the CLSM microscope 16 in the reflection configuration. 18a denotes a ray striking a separating baffle or beam splitter 20. The ray 18a which has passed through the beam splitter 20 reaches the microscope 16; the light 22 reflected by the photonic crystal positioned underneath the microscope, striking the beam splitter 20, is deviated towards a detector not shown in the figure.

FIG. 3, on the other hand, illustrates operation of the CLSM microscope 16 in the luminescence configuration. 18a denotes the incident ray which, passing first through a dichroic mirror 24 and then the microscope 16, reaches the photonic crystal, excites the Rhodamina 6G which produces a photoluminescence signal 26. This signal 26 is deviated by the mirror 24 and reaches a passband optical filter 28 which allows only the wavelengths emitted by the fluorescent molecule to pass through.

FIG. 4 shows some images of a sample treated with this process. The image 4a shows six successive infiltrations performed in the region of the single pore, in the sample with a greater lattice constant, which produce a well defined linear defect. The image was obtained with the microscope in the luminescence configuration, exciting at a wavelength of 488 nm and detecting the photoluminescence signal emitted by the Rhodamina. The microscope is provided with a dichroic mirror centred at 510 nm and a passband filter which transmits within the range of 520-560 nm so as to have a good superimposition with the signal produced by the Rhodamina.

4b denotes the image obtained instead with the microscope in the reflection configuration. In this case the dichroic mirror has been replaced by a standard 50/50 beam splitter and the passband filter has been eliminated.

Since the samples consist of air holes organized with triangular symmetry, the dark regions, indicating low reflectivity, correspond to the air holes, while the light regions indicate the silicon zones situated between the holes.

The image 4c shows the same sample portion as the image 4a obtained, again in luminescence mode, 24 hours after carrying out the infiltration process. As can be easily noted, there are no significant modifications. This is an indication of the stability of the process.

FIG. 4d shows the same sample portion as the image 4a, again obtained in luminescence mode, where however the passband filter has been replaced by a passband filter centred at 585 nm, which has greater superimposition with the signal produced by the Rhodamina. In this case, as can be seen, the photoluminescence is emitted only from three pores. If we compare FIG. 4d with FIG. 4e, which is the same image obtained in reflection mode, it can be established that the signal is located on the edge of the pores. From this it can be concluded that, after one day, the Rhodamina inside the pores is still in solution form, while any droplets of liquid accidentally deposited around the pores, on the surface of the sample, are evaporated. In fact, small volumes of liquid evaporate rapidly if they are in a free space or on a surface; vice versa, within the pores, the capillary forces slow down enormously this evaporation.

FIGS. 5a and 5b show the images, in emission and reflection mode, respectively, of a single infiltrated pore with a radius of 550 nm. The graphs 5c and 5d show the horizontal and vertical profiles, respectively, taken at the centre of the images 5a and 5b. The perfect superimposition between the maximum of the photoluminescence curves and the minimum of the reflection curves confirms that the solution is present only in the individual pore selected.

When carrying out infiltration tests on pores in samples with a smaller lattice constant, i.e. of 1.5 μm, significant differences were not noted. This leads one to believe that this method may be applied also to samples with lattice constants of up to 700 nm, this value corresponding to crystals having a photonic band gap in the range of wavelengths used for telecommunications, namely about 1.5 μm.

FIG. 6a shows the periodic variation of the dielectric constant with the introduction of a defect. The pores are characterized by a radius of 0.45a where a is the lattice constant of the photonic crystal; the pore infiltrated with water is indicated by 30 and is characterized by a dielectric constant of 1.77, while the silicon substrate has a dielectric constant of 12.

FIG. 6b shows the spatial distribution 32 of the mode TE of the electric field, introduced by the defect, at a wavelength of 0.47 ωa/2 μc. The creation of the defect produces a localized state, as is evident from the marked localization of the electric field's intensity around the position of the infiltrated pore.

FIG. 7 shows an example of an optical device created with this method. 34 denotes a waveguide formed with the successive microinfiltration of liquid, repeating a basic block of four infiltrated pores organized in a predetermined geometry. The image was obtained in the emission configuration.

FIG. 8 shows the band diagram for propagation of the modes TE of the structure of FIG. 7. 36 denotes the photonic band gap of the crystal which extends from a wavelength of 0.3 ωa/2 μc to a wavelength of 0.5 ωa/2 μc; the wavelength causes the appearance, at the wavelength of 0.45 ωa/2 μc, of a small band of guided modes 38 within this range 36 where the propagation of light is inhibited.

FIG. 9a shows the intensity of the electric field and FIG. 9b shows the magnetic field associated with one of the modes TE introduced by the wave guide in the band gap of the photonic crystal.

FIG. 10a shows another example of an optical device created with this method, in particular an infiltration of an annular cavity 40 so that the magnetic field, (FIG. 10b), and the intensity of the electric field, (FIG. 10c), associated with one of the modes TE introduced by the waveguide in the band gap of the photonic crystal are localized in the region of the defect introduced.

By way of an alternative to the examples shown in FIGS. 7 to 10, with this method it is possible to obtain many other optical components such as, for example, micro-lasers, transistors, resonators, filters, optical switches or LEDs which may be combined to create a photonic circuit for the transmission of optical signals.

Naturally, the principle of the invention remaining the same, the embodiments and details of construction may be widely varied with respect to those described above and illustrated purely by way of a non-limiting example, without thereby departing from the scope of protection of the invention as defined in the appended claims.

1. Method for the creation of a rewritable photonic device inserted in a photonic crystal having a plurality of cavities, characterized in that it comprises the operation of injecting selectively into predetermined cavities a micro-quantity of a liquid so as to allow the introduction of permitted states within the photonic band gap of the crystal or the modification of the prohibited states.

2. Method according to claim 1, in which the liquid contains a tracer substance able to emit, if suitably excited, a radiation in the visible range so as to allow easy location of the said liquid inside the cavities.

3. Method according to claim 1 or 2, in which the liquid is a solvent, the vapour tension of which is such that injection of said liquid in the cavities causes a modification in the permanent photonic crystal for a period of not less than one day.

4. Method according to any one of the preceding claims, in which the liquid is chosen from among water, hydrocarbons, oils, liquid crystals, or suspensions of micro or nano-particles in a liquid.

5. Method according to claim 1, in which the liquid is capable of hardening.

6. Method according to claim 5, in which the liquid is chosen from resist liquids or liquid prepolymers.

7. Method according to any one of the preceding claims, in which the injection of liquid is monitored by a CLSM.

8. Method according to any one of the preceding claims, in which the injection is performed using a system of micro-pipettes and means for moving the micro-pipettes over the surface of the sample.

9. Method according to any one of the preceding claims, in which a controlled pressure which manages the infiltration of liquid is applied to the pipettes.

10. Method according to any one of the preceding claims, in which the liquid has a predetermined viscosity such as to allow administration by means of micropipettes.

11. Photonic device inserted in a photonic crystal having a plurality of cavities, which can be obtained by means of a method according to any one of claims 1 to 10 and comprising micro-quantities of a liquid selectively injected into the abovementioned cavities in a manner suitable for allowing the propagation of specific wavelengths otherwise inhibited or for allowing the formation of localized states.

12. Device according to claim 11, in which the liquid contains a substance able to emit, if suitably excited, a radiation in the visible range so as to allow easy location of the said liquid inside the cavities.

13. Device according to claim 11 or 12, in which the liquid is a solvent, the vapour tension of which is such that the injection of said liquid inside the cavities produces a modification in the permanent photonic crystal for a period of not less than one day.

14. Device according to any one of the preceding claims, in which the liquid is chosen from among water, hydrocarbons, oils, liquid crystals, or suspensions of micro or nano-particles in a liquid.

15. Device according to claim 11, in which the liquid is capable of hardening.

16. Device according to claim 15, in which the liquid is chosen from resist liquids or liquid prepolymers.

17. Photonic device according to any one of claims 1 to 16, consisting of a micro-laser or transistors or filters or optical guides or diverters or resonators or optical switches or LEDs.

18. Device according to any one of the preceding claims, in which said device is designed to be tunable by means of a mixture of liquids with a different refractive index.

19. Device according to any one of the preceding claims, in which said device is designed to be tunable by means of the application of an electric field.

20. Device according to any one of the preceding claims, in which said device is designed to be tunable by means of a variation in the temperature.
